(19) United States
(12) Patent Application Publication
(10) Pub. No.: US 2012/0011656 A1
(43) Pub. Date: Jan. 19, 2012

(54) CUSHION, KIT AND METHOD OF MANUFACTURE

(76) Inventor: Patrick Noel Daly, Co. Cork (IE)

(21) Appl. No.: 13/255,232

(22) PCT Filed: Mar. 17, 2010
(86) PCT No.: PCT/EP2010/053465

§ 371 Date: Sep. 7, 2011

(30) Foreign Application Priority Data
Mar. 18, 2009 (IE) 2009/0204
Sep. 30, 2009 (DE) 10 2009 043 730.4

(51) Int. Cl. A47C 7/18; B32B 27/40; B68G 7/00; A47C 4/54; A47C 7/02; B68G 11/04; B32B 5/24; B32B 27/06

(52) U.S. Cl. 5/652.1; 5/655.9; 5/655.3; 29/91.1

(57) ABSTRACT

There is provided a cushion (10) comprising an envelope (12) comprising at least an inner and outer layer (14, 16) of polyurethane material, and a resilient core (17) of an open-cell polyurethane foam material inside the envelope (12), wherein the envelope (12) is substantially air- and liquid-impermeable, and the inner layer (14) is at least partially attached to the outer layer (16) and the resilient core (17) so as to provide a plurality of microchannels of an outer surface of at least a top portion of the envelope (12), a kit comprising such cushion (10) and a removable cover, a cushion system and a method of manufacturing such a cushion (10).

The present invention relates to a cushion, particularly an inflatable cushion, a kit comprising a cushion, a cushion system and a method of manufacturing a cushion.

The provision of a cushion, e.g. a foam or air cushion, is well known in the art, especially for the purpose of alleviating, or reducing the incidence of, pressure sores. It is often desirable for cushions to be supplied for such use in a domestic or care home setting on an as-needed basis.

Inflatable cushions, for example self-inflating cushions comprising a polyurethane foam material are known. These cushions may be contained in covers which are typically weave-backed fabric with outer sprayed-on or spread-on plastic coatings. The cushions are placed inside covers. These covers can be removable by opening a zipper at one end of the cover, or by similar means. Such cushions typically comprise standard polyurethane foams and are usually made with more than one foam density/hardness to achieve a strategic absorption of load. U.S. Pat. No. 5,282,286 describes a self-inflating Wheelchair-cushion that is typically used to prevent Decubitus Ulcers in wheelchair users. This system utilises a plurality of resilient elements that are strategically linked within a sealed envelope which has a valve for intake and exhaust of air. The choice of foam elements is dictated by expected the load range exerted on the cushion when in use. The cushion described in U.S. Pat. No. 5,282,286 can be actively pressurised by a pump system. The Wheelchair cushion has a coated knit/woven surface sealed to and encapsulating the foam core. During use, the coating can be subject to wear and/or can easily be damaged, exposing the weave to the environment potentially resulting in contamination of the fabric or even the foam core. If the weave of the cover or the foam core units becomes contaminated, it is extremely difficult to clean, especially to disinfect, and specialist machinery may be required to achieve safe disinfection and/or decontamination. The process is expensive and inconvenient, and can be unsuccessful.

Thus, for the cushions outlined above, after use, especially after use in environments where a risk of contamination is high, such as in medical facilities, re-use of the cushion by or with another user can be problematic. For example, undesired microorganisms can be transferred by the cushion in case of an unsuccessful decontamination.

An inflatable air cushion is described in WO91/07937 and marketed by Frontier Therapeutics under the trade name “Repose”®. The cushion comprises skin sections sealed together around the edges of air chambers of the product and must be inflated by means of an air pump to a given pressure before use. The nature of the materials used to construct the “Repose”® cushion means that if a skin section is punctured it is not readily repairable and a new cushion must be obtained. Specifically, the cushion comprises an inner layer of air-impermeable material to which an outer layer of vapour permeable material is permanently attached in a bag like cover over the inner air-impermeable air cushion. In the event of contamination, it is not possible to access the inner air-impermeable layer without cutting the outer permeable cover to carry out a thorough cleaning or decontamination of the product. This is inconvenient and can, for example, increase the risk of cross-infection between patients significantly. For patients at risk from, or suffering from, pressure sores or open wounds, this can severely compromise the efficacy of treatment. As stated, the “Repose”® cushion does not wholly overcome the problem of cross-infection arising from successive uses of the cushion with different patients. If the outer permeable layer is damaged, microorganisms can pass the outer permeable layer and contaminate the cushion. Examples of such microorganisms include bacteria, fungi and viruses. For example, bacteria which are involved in typical hospital infections, such as Staphylococcus aureus, for example MRSA, MSSA, Clostridium difficile etc., can enter the “Repose”® cushion and remain in the cushion for a prolonged period of time or can grow/multiply. Also, a body support surface the cushion will be warmed by body heat of the user and can reach a temperature close to the temperature of the user's body, e.g. approximately 37° C. As a result, the cushion can provide ideal incubating/growth and retention conditions for bacteria.

Other cushions comprising foam with an outer cover of, for example, Polyurethane coated woven cover or similar materials are also widely known in the retail market. These cushions are easily damaged in a medical or therapeutic environment because of the flimsy nature of the outer coating materials used in their cover construction.

Standard cushions or mattresses are also unnecessarily high (in terms of product thickness from base to top) as they typically require a significant bulk/volume of foam to adequately support a patient and to provide a certain degree of pressure reduction or redistribution, which is required to carry load and prevent development of a pressure ulcer. By using these high cushions or mattresses the user, e.g. a patient, is at greater risk of falling from the cushion or in the case of a hospital bed and mattress, the height of the safety sides along the outer sides/periphery of the bed are minimised due the higher than necessary mattress underneath. This is particularly dangerous where the user is elderly or confused and where the safety sides (also known as cot sides) are a vital component in keeping the user on the mattress and/or inside the bed. Compressible self-inflating cushions, mats or “mattresses” are generally known for outdoor leisure use, for example camping purposes. Such a mat is available from Cascade Designs under the trade name “Therm-a-Rest®”. U.S. Pat. No. 3,872,525, U.S. Pat. No. 4,025,974 and U.S. Pat. No. 4,624,877 describe similar types of mats. A typical mat of this type comprises a relatively thin core of conventional foam material, in particular a firmer type of open-celled foam material which is bonded on both sides to an air-impermeable external weave/cloth-based envelope which forms the outer surface of the mat. Bonding of the foam material to the envelope material prevents movement of the two materials with respect to one another and maintains the foam in tension. For leisure uses of self-inflating mats this is an advantage. A valve is provided to allow the user to let air into or out of the chamber defined by the air-impermeable envelope. The foam is generally selected to be compressible so that the mat can be rolled or folded, with the valve open, so expelling air and causing the mat to adopt a relatively compact state. Closing the valve with the mat in this condition maintains the mat in the compact state, which is advantageous for storage and transportation. When the mat is required for use, the valve is opened and the natural resilience of the foam core causes the foam to expand back to its original state so drawing air into the mat through the open valve. If desired, air may be blown or pumped through the valve by the user. The valve is then closed and the mat is ready for use. By bonding the foam material and the envelope material together it is possible to prevent “ballooning” of the mat where the weight of a person lying on the mat compresses the foam only in certain areas causing a re-distribution of air within the mat so that in some areas the envelope material stands apart from the foam material. Ballooning of this sort could render the mat less supportive to the user.

Such mats, or cushions, intended for outdoor use must necessarily be made as light as possible, with relatively thin and lightweight foams, so that they can be carried in a back-pack, for example. Camping mats are also designed to provide the greatest possible degree of insulation so that they are suitable for use in cold outdoor conditions. In order to achieve this, in conjunction with minimum weight and volume (specifically, thickness), a foam with a high insulation value and a suitable air/foam ratio is used.

As the envelope of the mat is weave/cloth-based, it is easily contaminated and difficult to decontaminate and/or clean. Furthermore, it can cause sweating of the user lying thereon, which can facilitate or increase microbial growth.

Due to the woven structure of the outer side of the sealed fabrics, cleaning and/or decontamination of the outer side is difficult, inconvenient and cost intense, and typically requires aggressive and specialised decontamination machinery, procedures or both.

It is an object of the present invention to overcome or at least reduce the problems associated with the prior art.

This is achieved by a cushion with a substantially air- and liquid-impermeable envelope of at least two layers of polyurethane material, which is at least partially attached to a resilient core of an open-cell polyurethane foam material inside the envelope.

As used herein, the term cushion refers to a cushion, pillow, mat, mattress, mattress cover, mattress overlay, a supporting structure, such as a support for a body portion or part, e.g. a heel support, a pad-like support for a user, or the like. The cushion can be suitable for use in a domestic, hospital or care home setting on an as-needed basis.

According to a first aspect of the present invention there is provided a cushion, particularly a substantially self-inflating cushion, comprising an envelope comprising at least an inner and outer layer of polyurethane material and a resilient core of an open-cell polyurethane foam material inside the envelope. The envelope is substantially air- and liquid-impermeable. The inner layer is at least partially attached, e.g. bonded such as heat bonded, to the outer layer and the resilient core so as to provide a plurality of microchannels of an outer surface of at least a top portion of the envelope, and at least a base portion of the envelope comprises a reinforcing fabric layer arranged between the inner and outer layer. The plurality of microchannels of the outer surface of at least a top portion of the envelope, particularly of the outer layer, substantially corresponds with a topology of a surface of the open-cell polyurethane foam material of the resilient core to which the inner layer is attached. Advantageously, the microchannels provide for an improved vapour diffusion and/or ventilation of a user.

The liquid impermeable envelope prevents or at least reduces contamination. A liquid, such as body fluid, water, or the like, cannot pass the envelope and contaminate the resilient core. Moreover, the cushion can be cleaned easily and instantly. It will be appreciated that the envelope comprising at least the inner and outer layer of polyurethane material also has an improved air-tightness, even under load and over time.

The envelope is further skin-friendly and provides good comfort to a user, with characteristics similar to air or gel based cushions. In addition, as the envelope is substantially capable of stretching, shear and friction forces on the user's skin and tissues are advantageously reduced. The envelope allows the cushion to conform very closely to the shape of the user so that an area of contact between the user and the cushion is maximised, which reduces a pressure experienced by the user when using the cushion, which results from the user's weight, is reduced. This can further minimise or reduce the incidence of pressure sores or the like.

The polyurethane material of the inner and outer layers can be varied depending of the intended use. For example, for users whose risk of developing pressure sores is lower, a relatively heavier grade polymeric material for the outer layer can be more appropriate. For users at greater risk of pressure sores, the outer layer should be made as light and compliant as possible.

Advantageously, the reinforcing fabric between the inner and outer layers provides good puncture resistance and durability while maintaining the ability to easily clean and/or disinfect the envelope, particularly the outer layer.

The inner and outer layer together preferably have a thickness in the range of 0.05 mm to 0.5 mm.

The inner layer can form between 0.1% to 99.9% of a total thickness defined by the thickness of the inner and outer layers together, and the outer layer can form between 99.9% to 0.1% of the total thickness. For example, the inner layer may form substantially 45% of the total thickness with the outer layer forming the remaining substantially 55% of the total thickness, or, the inner layer may form substantially 55% of the total thickness with the outer layer forming the remaining substantially 45% of the total thickness. Most preferably the inner layer forms substantially 50% of the total thickness and the outer layer forms substantially 50% of the total thickness.

At least partial attachment of the inner layer to the outer layer and the resilient core is advantageous as movement of the envelope with respect to the resilient core is prevented or at least reduced.

In an embodiment, the envelope provides a sealed chamber for the resilient core. As a result, a thickness of the cushion can advantageously be reduced, for example to a thickness that is in a range of 14 cm to 8 cm, as air enclosed in the sealed chamber can carry a large part of the load generated by the user/occupant of the cushion. This also allows for an advantageously reduced thickness of the resilient core. A reduced thickness of the cushion further allows that, for example, bed sides (safety sides) can have a reduced height.

In a preferred embodiment, the envelope comprises at least one valve capable of controlling an air flow into or out of the sealed chamber. Additionally, a second, third or further valve can be comprised. Accordingly, the cushion can be compacted, e.g. compressed by rolling or folding the cushion when at least one valve is open such that air can escape the cushion. The compacted state can be retained by closing the valve or valves such that air cannot re-enter the cushion. It will be appreciated that compacting the cushion, e.g. after use, is advantageous, as the cushion can conveniently be transported or stored. Preferably, the cushion can be compressed to an extent that it can conveniently be carried under an arm or in a carry bag. Preferably a plurality of valves is provided to increase the flow rate of air into or out of the envelope. For example one or two valves can be provided at each corner/end of the envelope.

The cushion can be conveniently decompacted by, for example, allowing air to enter the cushion and retaining the air in the cushion, controlled by the or each valve.

In an embodiment, the sealed chamber is substantially filled by the resilient core.

In embodiments, the inner and outer layers have the same or a different polyurethane material. The polyurethane material can be thermoplastic polyurethane.

In embodiments the inner layer comprises a polyurethane material that has a low melting point which is in a range of 70° C. to 100° C. and/or the outer layer comprise/comprises a polyurethane material that has a high melting point which is in a range of 130° C. to 170° C.

Preferably, the inner layer is heat-bonded to the outer layer and the resilient core.

The inner, lower melting point, layer is capable of allowing heat bonding to the resilient core and/or to the outer layer. Preferably, sufficient heat is applied to soften or melt the inner, lower melting point, layer so that it at least partially penetrates the open-cell polyurethane foam to form a bond. Additionally or alternatively, a bonding material may be incorporated between the inner and outer layer and/or the resilient core.

The reinforcing fabric layer can extend from the base portion along a circumferential portion of the cushion.

In embodiments the reinforcing fabric layer is at least partially attached to the inner layer.

The reinforcing fabric layer can comprise a synthetic or natural material, e.g. a material selected from nylon, polyester, cotton, polyamide or the like.

In embodiments, an outer surface of a base portion of the cushion can be capable of providing friction. This is particularly advantageous as relative movement of the cushion and a base, such as a seat, bed, further cushion or the like is reduced. Preferably, the outer surface of the base portion comprises a rubberised or rubber-like material. For example, the material can be a softened polyurethane or similar.

In embodiments, the polyurethane foam material has a thickness which is in a range of 3 cm to 15 cm, for example in a range of 4 cm to 10 cm, especially 5 cm to 8 cm. Preferably, the thickness is determined in a decompressed state of the resilient core or the cushion.

The polyurethane core can have at least one recess. Preferably, the at least one recess is capable of providing fluid flow in the polyurethane core. Additionally or alternatively, the recess can be located at a periphery of the resilient core. For example, the core can have 1, 2, 3, 4, 5 or more recesses.

The recess(es) advantageously minimise or at least reduce the bulk and weight of the cushion, and may add to its flexibility.

In a preferred embodiment the at least one recess is at least one bore extending longitudinally and/or transversally in or through the polyurethane core.

If at least one recess extends from an internal side of the, or each, valve into the resilient core an air flow into or out of the cushion is improved, enhancing the speed at which the cushion can be compressed or decompressed, e.g. inflated or deflated. The recess(es) may, for example, be arranged along a diagonal or longitudinal axis of the cushion, e.g. from one valve located at one corner or end of the cushion to an opposite valve located at another corner or end of the cushion.

Additionally or alternatively the at least one recess is capable of providing an additional recess topology of the surface of the open-cell polyurethane foam material of the resilient core to which the inner layer is attached. The outer surface of the outer layer substantially corresponds with the additional recess topology, thereby advantageously improving vapour diffusion and/or an ventilation of the user, preventing excessive moisture build up. For example, the outer surface of the outer layer is provided with a waffle-like effect.

In embodiments the resilient core is substantially co-extensive with the envelope. Preferably, the foam core substantially fills a void defined by the envelope.

At least one handling means can be attached to the envelope. Preferably, the handling means is attached to the envelope such that the cushion is moveable, when in use, e.g. when a user is placed on the cushion. Particularly, the at least one handling means is selected from a strap, knob, carry bag, harness, side handle or the like. For example, the handling means can be attached to the base portion of the envelope such that at least two handles at each side of the cushion are provided. It will be appreciated that this allows lifting of the cushion with or without a user placed on the cushion.

In embodiments a cell size, e.g. an average cell size, of the foam material is substantially 1 mm or higher. The average cell size can be in a range of 1 mm to 3 mm, particularly 1.05 mm to 3 mm.

The foam material has a more open-celled construction than is conventional in the art. Polyurethane foams used in conventional cushions or mattresses typically have a very tight closed cell structure. A consequence is that air does not easily pass through the foam. The open-cell foam material of the invention provides an improved air flow through the resilient core to achieve a conveniently rapid deflation and inflation of the cushion, most preferably without the need for inflation assistance such as a pump or blowing into the cushion. Furthermore, topology of the surface of the open-cell polyurethane foam material of the resilient core to which the inner layer is attached provides the microchannels of the outer surface.

The cushion can be capable of transforming between an operating state and a compressed state controlled by the at least one valve.

In embodiments a removable cover that overlays at least the top portion and that is capable of providing vapour diffusion is comprised.

The washable, sealed envelope of multi-layer high stretch thermoplastic polyurethane, which is at least partially attached to the resilient core, and which is sealed around the periphery of the cushion provides a complete and durable barrier to contamination and a smooth surface which can easily be cleaned or decontaminated, for example by using antibacterial wipes, standard disinfectants and/or standard cleaning substances. The cushion is lightweight (at least in relation to gel-filled cushions), easily transportable, minimises the danger of cross-infection when used successively two or more users, and which provides a desired level of comfort and benefit.

According to a second aspect of the invention there is provided a kit comprising a removable cover capable of providing vapour diffusion and a cushion as hereinbefore and hereinafter described.

According to a third aspect of the invention there is provided a cushion system comprising a removable cover capable of providing vapour diffusion and a cushion as hereinbefore and hereinafter described.

According to a fourth aspect of the invention there is provided a method of manufacturing a cushion as hereinbefore and hereinafter described comprising the steps of heating at least a portion of an inner layer of a top portion of an envelope, comprising at least the inner layer and an outer layer of polyurethane material, to attach the inner layer to the outer layer and to a resilient core of an open-cell polyurethane foam material inside the envelope and to provide a plurality of microchannels of an outer surface of the top portion of the envelope.

Embodiments of the invention will now be described with reference to the accompanying drawings by way of example only.

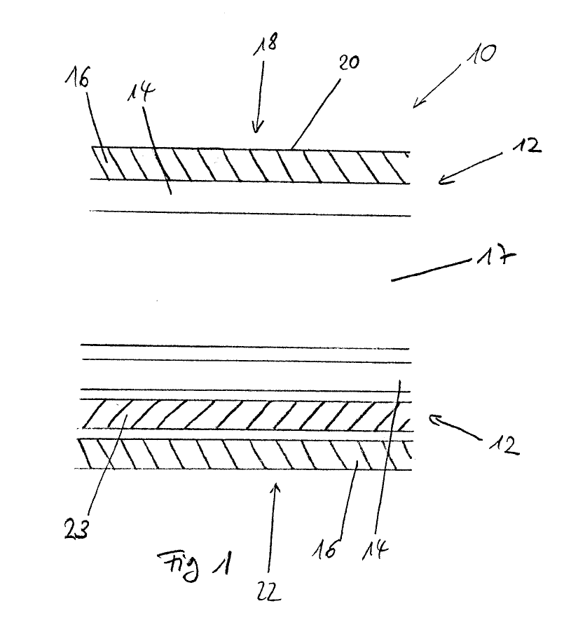

FIG. 1 shows a schematic cross sectional view of an embodiment of a cushion according to the invention,

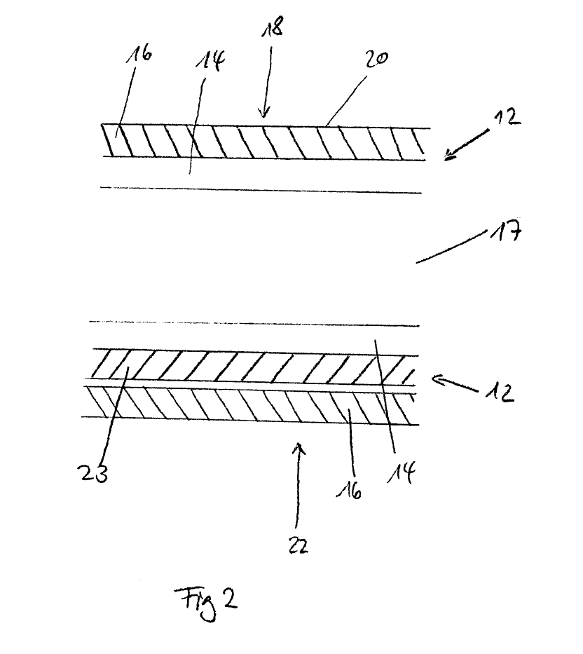

FIG. 2 shows a schematic cross sectional view of a further embodiment of the cushion as shown in FIG. 1,

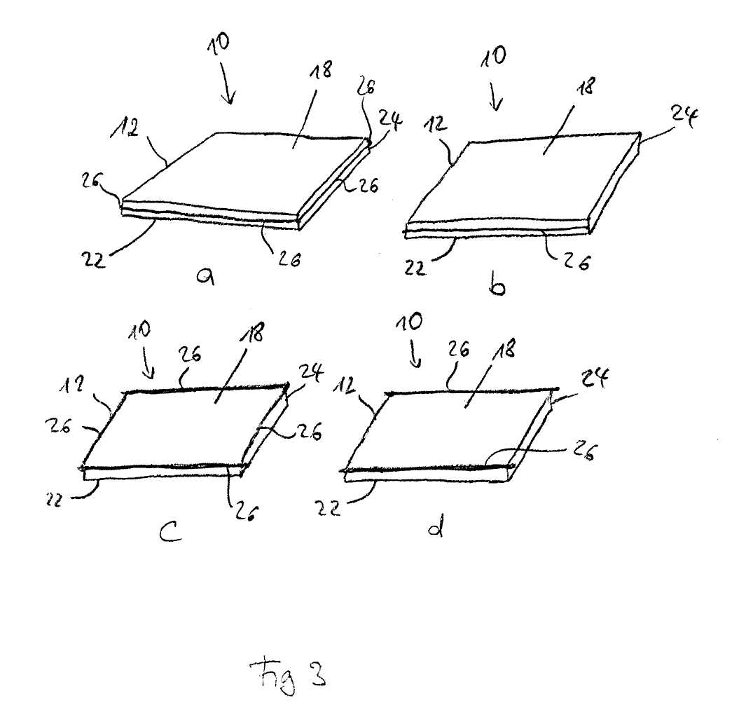

FIG. 3 shows a schematic perspective view of the cushion as shown in FIG. 1 or FIG. 2,

FIG. 4 shows a schematic cross sectional view of a part of the cushion as shown in FIG. 3a,

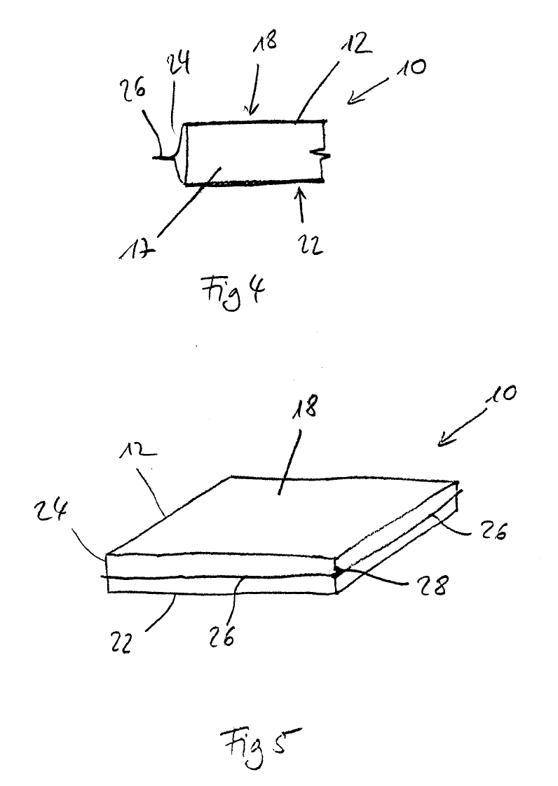

FIG. 5 shows a schematic perspective view of an embodiment of the cushion as shown in FIG. 3a,

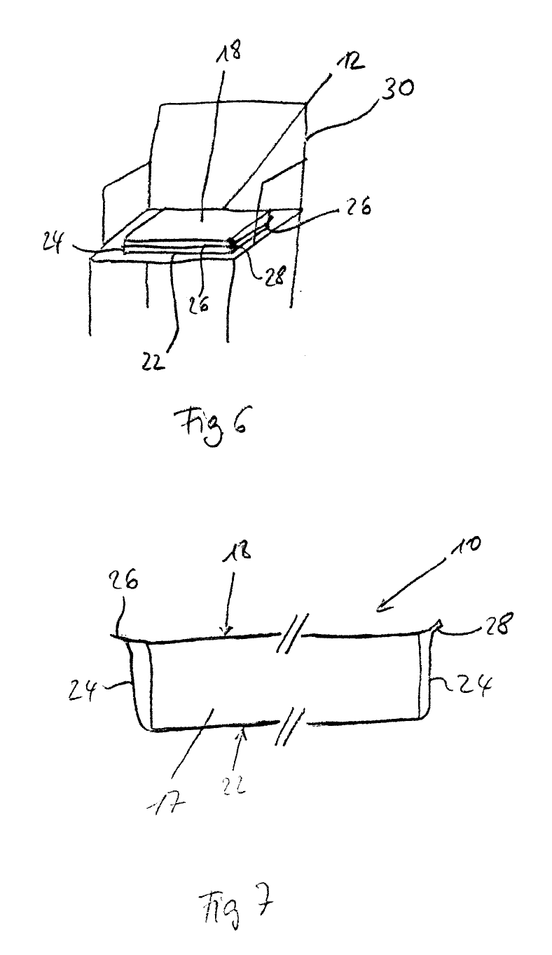

FIG. 6 shows a further schematic perspective view of the cushion as shown in FIG. 5,

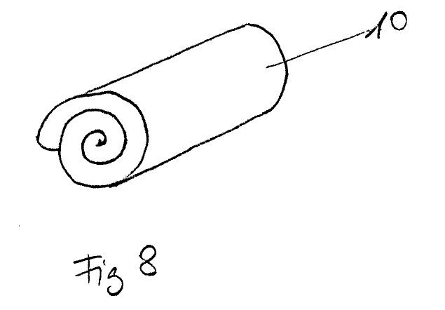

FIG. 7 shows a schematic cross sectional view of a further embodiment of the cushion as shown in FIG. 3c, and

FIG. 8 shows a schematic representation of the cushion as shown in FIG. 3 in a compacted state.

FIG. 1 shows a schematic cross sectional view of an embodiment of a cushion 10 according to the invention, with an envelope 12 with an inner layer 14 and an outer layer 16 of polyurethane material. A resilient core 17 of an open-cell polyurethane foam material is positioned inside the envelope 12. At a top portion 18 of the envelope 12 the outer layer 16 is attached to the resilient core 17 by the inner layer 14. Additionally a plurality of microchannels of an outer surface 20 of the top portion 18 can be provided.

At a base portion 22 of the envelope 12 a reinforcing fabric layer 23 is arranged between the inner and outer layer 14, 16.

It will be appreciated that the resilient core 17 can be one core element of a suitable configuration or can comprise more than one suitable core elements. For example, in one configuration, the resilient core 17 can comprise a first core element which faces a user when in use, and a second core element, which faces away from a user when in use, and resilience and/or hardness of the foam of the core elements can be adapted to an intended purpose.

Particularly, the second core element can have an open-cell, high resilience polyurethane foam material, which provides good support and durability.

The foam material can have a density in a range between 30 kg per cubic metre (kg/m³) to 50 kg/m³, and the hardness can be in a range between 80 Newtons and 175 Newtons.

The first core element can have a viscoelastic temperature sensitive polyurethane foam material. It will be appreciated that this provides good comfort and pressure reduction as well as heat sensitive conformity to the user to provide good pressure relief. The viscoelastic foam can have a density in a range of 40 kg/m³ and 60 kg/m³, and can have a hardness in a range between 60 and 110 Newtons at substantially 23° C.

It will be appreciated that other configurations are possible, for example a core comprising three or more core elements.

FIG. 2 shows a schematic cross sectional view of a further embodiment of the cushion 10 as shown in FIG. 1, in which the reinforcing fabric layer 23 is attached to the resilient core 17 by the inner layer 14.

FIG. 3 shows a schematic perspective view of embodiments the cushion 10 as shown in FIG. 1 or FIG. 2, wherein the top portion 18 and the base portion 22 of the envelope 12 of the cushion 10 are connected, e.g. joined, at a circumferential portion 24 of the cushion 10. The connection 26, e.g. a sealed seam or the like, is positioned substantially around the circumferential portion 24 (FIG. 3a), at two distant circumferential portions 24 (FIG. 3b), substantially around the circumferential portion 24 at a user facing side (FIG. 3c) or at two distant circumferential portions 24 at the user facing side (FIG. 3d). It will be appreciated that the connection 26 can have any other suitable position.

If the connection is placed at or close to the top portion of the cushion 10, the circumferential portion 24 can advantageously have the reinforcing fabric layer. In this case, the valve 28 is preferably positioned at or close to the top portion of the cushion 10.

FIG. 4 shows a schematic cross sectional view of a part of the cushion 10 as shown in FIG. 3a with the connection 26 of the top and base portion 18, 22 of the envelope 12 extending substantially around the circumferential portion 24.

FIG. 5 shows a schematic perspective view of an embodiment of the cushion 10 as shown in FIG. 3a with a valve 28 arranged at the circumferential portion 24, by which an air flow into or out of the cushion 10 can be controlled.

FIG. 6 shows a further schematic perspective view of the cushion 10 as shown in FIG. 5, wherein the cushion 10 is placed on a seat 30. it will be appreciated that the seat 30 can be any suitable seat, chair, bench or similar, for example, it can be a conventional seat in a patient's home, a hospital seat or the like.

FIG. 7 shows a schematic cross sectional view of a further embodiment of the cushion 10 as shown in FIG. 3c which further comprises a valve 28 at the circumferential portion 24 at a user facing side of the cushion 10.

FIG. 8 shows a schematic representation of the cushion 10 as shown in FIG. 3 in a compacted, i.e. rolled-up state.

### EXAMPLE

The top portion 18 and the base portion 22 of the envelope 12 of the cushion 10 as shown in FIG. 5 are joined at the circumferential portion 24, i.e. at the marginal edges, to form an airtight chamber. The resilient core 17 is disposed within the chamber and occupies substantially all of the volume of the chamber. The cushion 10 further comprises the valve 28, which, when open, allows the chamber to communicate with an exterior. Alternatively, the cushion 10 may comprise two or more valves 28. For example, one valve 28 may be provided at each end of the cushion 10, or two valves may be provided, respectively at opposed corners of the cushion 10, or one valve 28 may be provided at each corner of the cushion 10.

When the valve is open, air contained within the chamber (e.g. within the cells of the foam material and any voids formed in the foam material) is expelled through the open valve(s) 28 by compressing the cushion 10, e.g. by rolling the cushion 10 up.

After compressing the cushion 10, it is retained in its compressed state by closing the valve(s) 28. The cushion can then be easily transported or stored.

The cushion 10 is low weight and, when in the compressed state, it can easily be transported and/or stored.

Before use, the valve 28 of the cushion 10 is opened and the resilient core 17 assists in decompressing the cushion 10 back to its original condition, by drawing air into the chamber. It is possible to supplement this process by actively pressurising the chamber, e.g. by pumping air in to the chamber. This will improve a decompression speed or can provide a pressure within the chamber which is greater than atmospheric pressure, if required.

Thus, in addition to being conveniently portable to a location of use the cushion 10 can be “made ready” for a user with a minimum of action required from an operator such as the user or any personnel, e.g. medical personnel. Once the cushion 10 has (self-) inflated, the operator simply has to close the valve or valves 28. If required, the pressure within the cushion 10 can be adjusted (for example when the user is lying on the cushion), e.g., by releasing air through the valve 28. In this way, optimum conformance of the cushion 10 with the user can be achieved. Once the valve 28 has been used to set the cushion 10 in a desired condition, generally it need not be further adjusted.

1-23. (canceled)

24. A cushion comprising:
an envelope comprising at least an inner and outer layer of polyurethane material, and a resilient core of an open-cell polyurethane foam material inside said envelope; and
wherein said envelope is substantially air- and liquid-impermeable, and that said inner layer is at least partially attached to said outer layer and said resilient core so as to provide a plurality of microchannels of an outer surface of at least a top portion of said envelope.

25. The cushion as claimed in claim 24 further comprising a base portion of said envelope comprises a reinforcing fabric layer arranged between said inner and outer layer.

26. The cushion as claimed in claim 24, wherein said envelope provides a sealed chamber for said resilient core.

27. The cushion as claimed in claim 26, wherein said envelope further comprises at least one valve operable to allow air into or out of said sealed chamber.

28. The cushion as claimed in claim 27, wherein said cushion being capable of transforming between an operating state to a compressed state controlled by said at least one valve.

29. The cushion as claimed in claim 26, wherein said sealed chamber is substantially filled by said resilient core.

30. The cushion as claimed in claim 25, wherein said inner layer comprises a polyurethane material having a low melting point being in a range of 70° C. to 100° C. and said outer layer comprises a polyurethane material having a high melting point being in a range of 130° C. to 170° C.

31. The cushion as claimed in claim 25, wherein said reinforcing fabric layer extends from said base portion along a circumferential portion of said cushion.

32. The cushion as claimed in claim 25, wherein said reinforcing fabric layer is at least partially attached to said inner layer.

33. The cushion as claimed in claim 25, wherein said reinforcing fabric layer comprises a material selected from the group consisting of nylon, polyester, cotton and polyamide.

34. The cushion as claimed in claim 24 further comprising a base portion having an outer surface capable of providing friction.

35. The cushion as claimed in claim 24, wherein said polyurethane foam material has a thickness being in a range of 3 cm to 15 cm.

36. The cushion as claimed in claim 24, wherein said resilient core has at least one recess capable of providing fluid flow in said polyurethane core.

37. The cushion as claimed in claim 36, wherein said at least one recess is at least one bore extending at least one of longitudinally and transversally and at least one of in and through said resilient core.

38. The cushion as claimed in claim 24, wherein said resilient core is substantially co-extensive with said envelope.

39. The cushion as claimed in claim 24 further comprising at least one handling means attached to said envelope such that, in use, said cushion is moveable, and wherein said at least one handling means is selected from the group consisting of a strap, knob, carry bag, harness, and side handle.

40. The cushion as claimed in claim 24, wherein said foam material has an average cell size in a range of 1 mm to 3 mm.

41. The cushion as claimed in claim 24 further comprising a removable cover that overlays at least said top portion and that is capable of providing vapour diffusion.

42. A cushion kit comprising:
an envelope comprising at least an inner and outer layer of polyurethane material, and a resilient core of an open-cell polyurethane foam material inside said envelope, said envelope is substantially air- and liquid-impermeable, and said inner layer is at least partially attached to said outer layer and said resilient core so as to provide a plurality of microchannels of an outer surface of at least a top portion of said envelope; and
a removable cover capable of providing vapour diffusion.

43. A method of manufacturing a cushion, said method comprising the steps of:
heating at least a portion of an inner layer of a top portion of an envelope comprising at least said inner layer and an outer layer of polyurethane material;
attaching said inner layer to said outer layer and to a resilient core of an open-cell polyurethane foam material inside said envelope; and
providing a plurality of microchannels of an outer surface of said top portion of said envelope.
